(19) United States
(12) Patent Application Publication
(10) Pub. No.: US 2025/0254146 A1
(43) Pub. Date: Aug. 7, 2025

(54) SYSTEMS AND METHODS FOR PROVIDING FIREWALLS AND AUTHENTICATORS FOR SMART TERMINALS

(71) Applicant: JPMORGAN CHASE BANK, N.A., New York, NY (US)

(72) Inventors: Christopher ROTSAERT, Tampa, FL (US); Robert LOPEZ, Gulrport, FL (US); Carlos ROMERO, Brooksville, FL (US); Michael JOHNSON, East Rockaway, NY (US)

(21) Appl. No.: 19/045,918

(22) Filed: Feb. 5, 2025

Related U.S. Application Data
(60) Provisional application No. 63/550,420, filed on Feb. 6, 2024.

(51) Int. Cl. H04L 9/40

(52) U.S. Cl. CPC H04L 63/0236; H04L 63/20

(57) ABSTRACT

Systems and methods for providing firewalls and authenticators for smart terminals are disclosed. In one embodiment, a method may include: (1) receiving, by a smart terminal and from a browser, a browsing request to access a Uniform Resource Locator (URL) or an address for externally hosted content, wherein the smart terminal is prevented from directly accessing the URL or the address; (2) routing, by the smart terminal, the browsing request to a secure server; (3) checking, by the secure server, the URL or the address against an allowed list or a prohibited list; (4) directing, by the secure server, the browser to the URL or the address in response to the URL or the address being on the allowed list, or the URL or the address not being on the prohibited list; and (5) providing, by the secure server, a secure connection between the browser and the URL or the address.

### RELATED APPLICATIONS

This application claims priority to, and the benefit of, U.S. Provisional Patent Application Ser. No. 63/550,420, filed Feb. 6, 2024, the disclosure of which is hereby incorporated, by reference, in its entirety.

### BACKGROUND OF THE INVENTION

### 1. Field of the Invention

Embodiments are generally directed to systems and methods for providing firewalls and authenticators for smart terminals.

### 2. Description of the Related Art

Payment terminals are required to comply with the Payment Card Industry (PCI) PIN Transaction Security (PTS) Point-of-Interaction (POI) specification. This specification requires that all prompts presented to a customer are under the control of the cryptographic unit of the device. This prevents the possibility of prompts for sensitive data entry (e.g., primary account number (PAN) or PIN) when the output is not encrypted.

This level of security, however, becomes an issue with terminals that use certain operating systems, such as the ANDROID AOSP (an open-source version of the ANDROID operating system provided by Google). Manufacturers of the payment terminals need to harden the source to disable functionalities and services to be compliant; as a result, the ANDROID build may not pass requirements for other services, such as Google's Google Mobile Services (GMS).

Because of this, workarounds, such as implementing alternative solutions for the services at the Android binary space partitioning (BSP) level, are used, but the results require different APIs. This requires additional efforts from application developers, such as adapting their applications to each different vendor.

For the use case with an installed application, the application is required to be authenticated and signed by the manufacturer or acquirer (which may delegate the signature to the developer) with responsibility to comply with the PCI requirements.

### SUMMARY OF THE INVENTION

Systems and methods for providing firewalls and authenticators for smart terminals are disclosed. In one embodiment, a method may include: (1) receiving, by a smart terminal and from a browser, a browsing request to access a Uniform Resource Locator (URL) or an address for externally hosted content, wherein the smart terminal is prevented from directly accessing the URL or the address; (2) routing, by the smart terminal, the browsing request to a secure server; (3) checking, by the secure server, the URL or the address against an allowed list or a prohibited list; (4) directing, by the secure server, the browser to the URL or the address in response to the URL or the address being on the allowed list, or the URL or the address not being on the prohibited list; and (5) providing, by the secure server, a secure connection between the browser and the URL or the address.

In one embodiment, a security tool prevents the smart terminal from directly accessing the URL or the address.

In one embodiment, the allowed list or the prohibited list is based on a security policy.

In one embodiment, the allowed list or the prohibited list is provided by an application development service.

In one embodiment, traffic to and from the browser flows through the secure server.

In one embodiment, the secure server monitors the traffic between the browser and the secure server.

In one embodiment, the method may also include signing, by the secure server, content communicated between the URL or the address and the browser.

According to another embodiment, a system may include: a smart terminal executing a browser computer program; a secure server executing a secure server computer program; and a database comprising an allowed list or a prohibited list of uniform resource locators (URLs) or addresses hosting external content. The smart terminal receives, from a browser, a browsing request to access a URL or an address for externally hosted content, wherein the smart terminal is prevented from directly accessing the URL or the address; the smart terminal routes the browsing request to the secure server; the secure server computer program checks the URL or the address against the allowed list or the prohibited list; the secure server computer program directs the browser to the URL or the address in response to the URL or the address being on the allowed list, or the URL or the address not being on the prohibited list; and the secure server provides a secure connection between the browser and the URL or the address.

In one embodiment, a security tool executed by the smart terminal prevents the smart terminal from directly accessing the URL or the address.

In one embodiment, the allowed list or the prohibited list is based on a security policy.

In one embodiment, the allowed list or the prohibited list is provided by an application development service.

In one embodiment, traffic to and from the browser flows through the secure server.

In one embodiment, the secure server monitors the traffic between the browser and the secure server.

In one embodiment, the secure server computer program signs content communicated between the URL or the address and the browser.

According to another embodiment, a non-transitory computer readable storage medium may include instructions stored thereon, which when read and executed by one or more computer processors, cause the one or more computer processors to perform steps comprising: receiving, from a browser, a browsing request to access a Uniform Resource Locator (URL) or an address for externally hosted content, wherein the smart terminal is prevented from directly accessing the URL or the address; checking the URL or the address against an allowed list or a prohibited list; directing the browser to the URL or the address in response to the URL or the address being on the allowed list, or the URL or the address not being on the prohibited list; and providing a secure connection between the browser and the URL or the address.

In one embodiment, a security tool prevents the smart terminal from directly accessing the URL or the address.

In one embodiment, the allowed list or the prohibited list is based on a security policy.

In one embodiment, the allowed list or the prohibited list is provided by an application development service.

In one embodiment, traffic to and from the browser flows through the secure server.

In one embodiment, the non-transitory computer readable storage medium may also include instructions stored thereon, which when read and executed by the one or more computer processors on a smart terminal, cause the one or more computer processors to perform steps comprising: signing content communicated between the URL or the address and the browser.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for providing firewalls and authenticators for smart terminals according to an embodiment;

FIG. 2 illustrates a method for providing firewalls and authenticators for smart terminals according to an embodiment;

FIG. 3 illustrates a method for providing firewalls and authenticators for smart terminals according to another embodiment; and

FIG. 4 depicts an exemplary computing system for implementing aspects of the present disclosure.

### DETAILED DESCRIPTION OF PREFERRED EMBODIMENTS

Systems and methods for providing firewalls and authenticators for smart terminals are disclosed. Examples of smart terminals may include payment terminals (e.g., point of sale devices). Embodiments may provide a secure server that may act as a firewall and authenticator for external content for a smart terminal, such as a point-of-sale device. The secure server may manage an access list (e.g., an allowed list or prohibited list of Uniform Resource Locators (URLs)) and other externally hosted content. The server may filter and sign every content in order to comply with the PCI PTS requirement that any possible content prompted to user to be acquirer controlled.

In embodiments, the acquirer may be accountable to ensure that the smart terminal is operated according to the security policy. Specifically, for content that is not running on the smart terminal itself (which is not evaluated by an independent entity (e.g., a PCI recognized laboratory), the acquirer, which should enforce compliance to entities (e.g., app developers, merchants, etc.) is accountable to have only compliant applications or content running on the smart terminal. For example, before an application can be downloaded and/or installed on the smart terminal it may need to be signed. Hardware and/or software on the smart terminal may enforce this requirement and may verify the signature.

In one embodiment, the application may be required to be signed by the acquirer, a delegate of the acquirer (e.g., application developer that is contractually obligated to comply with security requirements), etc.

Hardware and/or software on the smart terminal may require that all communication from and to the smart terminal flow through the secure server. Thus, the secure server may act as a proxy to the open world. The secure server may be configured with an allowed list (or prohibited list) of URLs authorized to be accessible by the smart terminal. The list may be under the responsibility of the manufacturer or acquirer (which may delegate to application developer or merchant).

The data from the servers hosting the authorized URLs may be restricted based on Media Access Control (MAC) addresses so that content integrity and authenticity is ensured between the secure server and the smart terminal. It may sign the content and the smart terminal may verify this signature.

The secure server may also scan security vulnerabilities from the app/merchant, perform anti-virus screening, log records for security audits, etc.

Embodiments may enable the use of a web browser on a smart terminal without compromising on the security of the solution. It may also eliminate or reduce the developers' need to re-code some functions to replace missing APIs/services.

Thus, embodiments may ensure that all prompts are considered to be secure, thereby preventing, for example, a prompt to enter a PIN in an unsecure context. Unsigned scripts such as those are prevented from being executed by the smart terminal, thereby eliminating vulnerabilities.

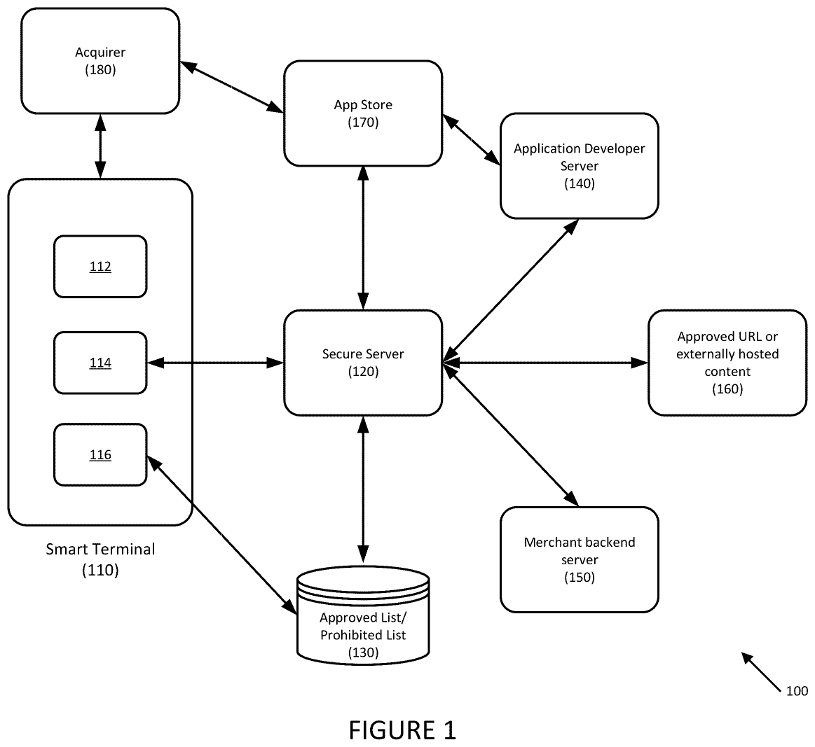

Referring to FIG. 1, a system for providing firewalls and authenticators for smart terminals is disclosed according to an embodiment. System 100 may include smart terminal 110, which may execute operating system 112 and computer program 114. Operating system 112 may be any suitable operating system, including the ANDROID operating system, the LINUX operating system, a Real-Time Operating System (RTOS), etc.

Computer program 114 may be a browser or similar that may access secure server 120. Computer program 114 may be restricted, by hardware and/or software, of accessing any other external device other than secure server 120.

In one embodiment, smart terminal 110 may manage and control network traffic directly on the device using on-device virtual private network (VPN) service 116. An example of such is a “VPN sinkhole.” Smart terminal may leverage on-device VPN service 116 to intercept, analyze, and potentially block or redirect specific types of network requests, such as a browsing request. Thus, in such an embodiment, secure server 120 may not be necessary.

Secure server 120 may maintain list 130 of allowed or prohibited URLs and other externally hosted content. When computer program 114 attempts to access a URL or externally hosted content, secure server 120 may verify that smart terminal 110 is allowed to access the URL or other address by comparing the URL or address to the allowed list or the prohibited list 130. If the request is allowed (e.g., the URL is on the allowed list, or is not on the prohibited list), computer program 114 may be authorized to access approved URL or externally hosted content 160.

In one embodiment, the URLs or addresses on the allowed list or the prohibited list 130 may be provided by application developer server 140.

In one embodiment, acquirer 180 may control the operation of smart terminal 110. For example, acquirer 180 may select and set the security policies that are to be enforced by smart terminal 110 and may sign content and applications that may be downloaded and installed on smart terminal 110.

In one embodiment, smart terminal 110 may verify the signature on the content and applications (e.g., the acquirer's signature) before the content or applications are downloaded and/or installed in order to comply with the requirements that only signed content can be executed and that only secure prompts are displayed smart terminal 110.

Computer program 114 may also be approved to access merchant backend server 150.

System 100 may further include application store 170, which may provide approved applications for downloading smart terminal 110. In general, applications that are available in application store 170 are signed by the host of application store 170. In addition to the signature of the host, the applications may also be signed by acquirer 180 before the applications can downloaded to smart terminal 110.

In one embodiment, application store 170 may filter the applications available for download to smart terminal 110 based on the inclusion of the signature of acquirer 180.

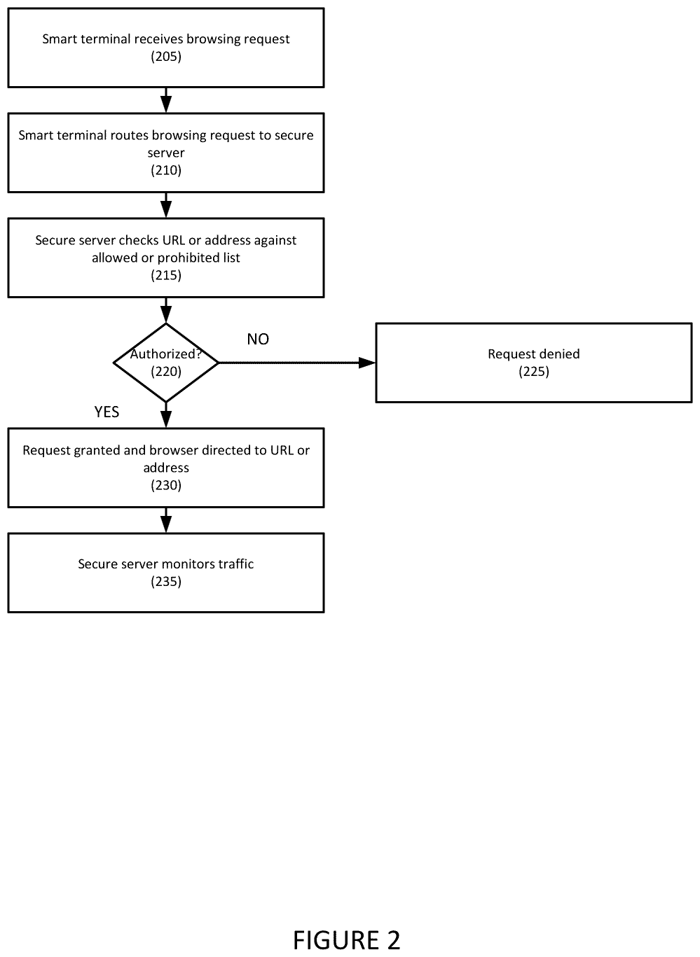

Referring to FIG. 2, a method for providing firewall and authenticator for smart terminals is disclosed.

In step 205, a smart terminal may receive a browsing request on a browser or similar. The request may be to access a URL or an address for externally hosted content. In one embodiment, the smart terminal may be prohibited from accessing the URL or address directly. For example, a security tool may prevent the access.

In step 210, the smart terminal may route the request to a secure server.

In step 215, a computer program executed by the secure server may check the URL or address against an allowed list of approved URLs or addresses, or a prohibited list of unapproved URLs or addresses. In one embodiment, the allowed list and/or the prohibited list may be provided by an application development service.

In step 220, if the URL or address is not authorized (e.g., the URL or address is not on the allowed list, or is on the prohibited list), in step 225, the request may be denied, and the smart terminal may not access the URL or the address.

If the URL or address is allowed (e.g., the URL is on the allowed list, or is not on the prohibited list), in step 230, the request may be granted, and the browser may be directed to the URL or address.

In step 235, the secure server may monitor the traffic between the browser and the URL or address. In one embodiment, hardware and/or software on the smart terminal may require that all traffic to/from the browser flows through the secure server, which ensures that the communication channel and the content are both secure.

In one embodiment, the secure server may sign all content in order to comply with the PCI PTS requirement that any possible content prompted to user to be acquirer controlled.

In one embodiment, the traffic to/from the browser may flow through the secure server until the connection with the URL or address is disconnected.

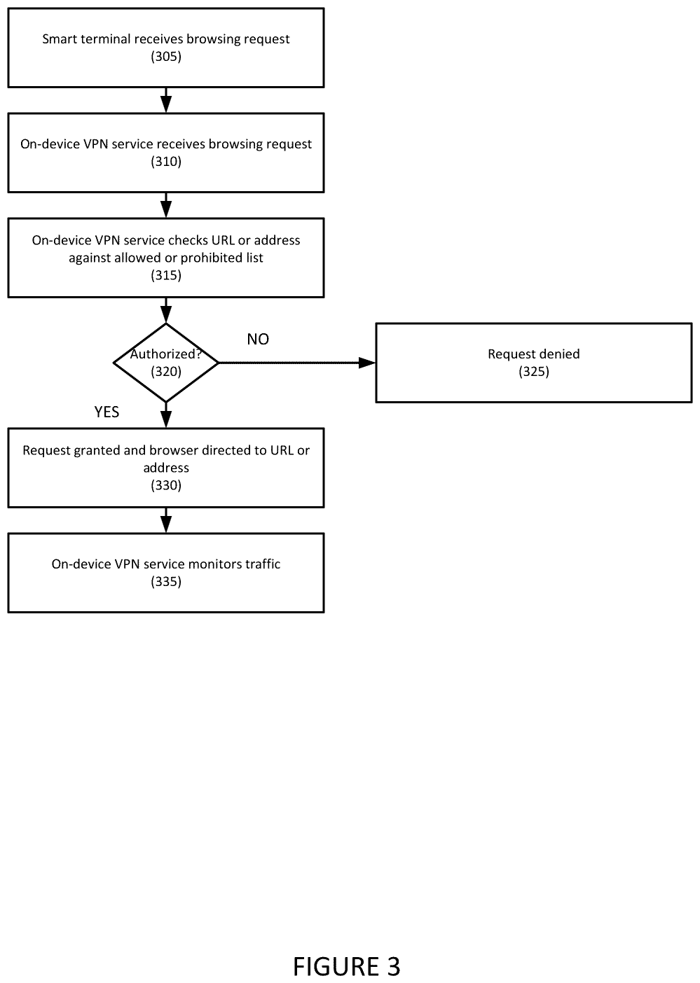

Referring to FIG. 3, a method for providing firewall and authenticator for smart terminals is disclosed according to another embodiment. Rather than routing the browsing request to a secure server, in embodiments, the smart terminal may leverage an on-device VPN framework to intercept, analyze, and potentially block or redirect the browsing request.

For example, the smart terminal may run an on-device VPN service locally that acts as a network filter on the device itself. The on-device VPN service captures all network traffic, both incoming and outgoing, allowing it to inspect and manipulate this traffic as needed.

The on-device VPN service may analyze the traffic to identify requests, such as browsing requests, to specific domains or IP addresses, by examining the destination of each network packet. The analysis can be based on predefined rules or lists, such as known malicious domains, ad servers, or tracking services.

Once identified, the on-device VPN can redirect these requests to a “sinkhole” address, which is typically a non-routable or local address. This effectively nullifies the request, preventing it from reaching its intended destination.

Alternatively, the on-device VPN can block the request entirely, stopping any data from being sent or received.

If the browsing request is authorized, the browsing request may be granted, and the browser may be directed to the URL of address in the browsing request.

In step 305, a smart terminal may receive a browsing request on a browser or similar. The request may be to access a URL or an address for externally hosted content. In one embodiment, the smart terminal may be prohibited from accessing the URL or address directly. For example, a security tool may prevent the access.

In step 310, an on-device VPN service executed on the smart terminal may receive the request.

In step 315, the on-device VPN service may check the URL or address against an allowed list of approved URLs or addresses, or a prohibited list of unapproved URLs or addresses. In one embodiment, the allowed list and/or the prohibited list may be provided by an application development service.

In step 320, if the URL or address is not authorized (e.g., the URL or address is not on the allowed list, or is on the prohibited list), in step 225, the request may be denied, and the smart terminal may not access the URL or the address. For example, the browsing request may be routed to a “sinkhole” address such as a non-routable or local address.

In another embodiment, the request may be blocked entirely.

If the URL or address is allowed (e.g., the URL is on the allowed list, or is not on the prohibited list), in step 330, the request may be granted, and the browser may be directed to the URL or address.

In step 335, the on-device VPN service may monitor the traffic between the browser and the URL or address.

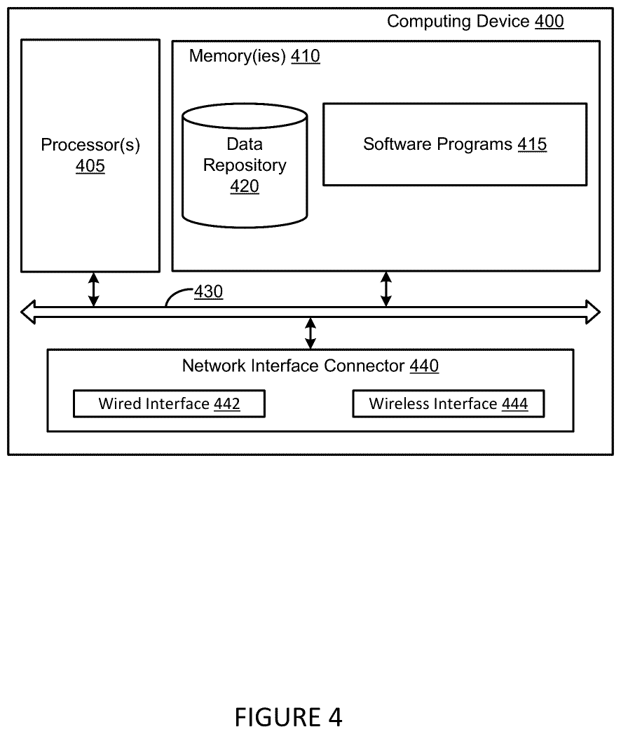

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a smart terminal and from a browser, a browsing request to access a Uniform Resource Locator (URL) or an address for externally hosted content, wherein the smart terminal is prevented from directly accessing the URL or the address;
routing, by the smart terminal, the browsing request to a secure server;
checking, by the secure server, the URL or the address against an allowed list or a prohibited list;
directing, by the secure server, the browser to the URL or the address in response to the URL or the address being on the allowed list, or the URL or the address not being on the prohibited list; and
providing, by the secure server, a secure connection between the browser and the URL or the address.

2. The method of claim 1, wherein a security tool prevents the smart terminal from directly accessing the URL or the address.

3. The method of claim 1, wherein the allowed list or the prohibited list is based on a security policy.

4. The method of claim 1, wherein the allowed list or the prohibited list is provided by an application development service.

5. The method of claim 1, wherein traffic to and from the browser flows through the secure server.

6. The method of claim 5, wherein the secure server monitors the traffic between the browser and the secure server.

7. The method of claim 1, further comprising:
signing, by the secure server, content communicated between the URL or the address and the browser.

8. A system, comprising:
a smart terminal executing a browser computer program;
a secure server executing a secure server computer program; and
a database comprising an allowed list or a prohibited list of uniform resource locators (URLs) or addresses hosting external content;
wherein:
the smart terminal receives, from a browser, a browsing request to access a URL or an address for externally hosted content, wherein the smart terminal is prevented from directly accessing the URL or the address;
the smart terminal routes the browsing request to the secure server;
the secure server computer program checks the URL or the address against the allowed list or the prohibited list;
the secure server computer program directs the browser to the URL or the address in response to the URL or the address being on the allowed list, or the URL or the address not being on the prohibited list; and
the secure server provides a secure connection between the browser and the URL or the address.

9. The system of claim 8, wherein a security tool executed by the smart terminal prevents the smart terminal from directly accessing the URL or the address.

10. The system of claim 8, wherein the allowed list or the prohibited list is based on a security policy.

11. The system of claim 8, wherein the allowed list or the prohibited list is provided by an application development service.

12. The system of claim 8, wherein traffic to and from the browser flows through the secure server.

13. The system of claim 12, wherein the secure server monitors the traffic between the browser and the secure server.

14. The system of claim 8, wherein the secure server computer program signs content communicated between the URL or the address and the browser.

15. A non-transitory computer readable storage medium, including instructions stored thereon, which when read and executed by one or more computer processors on a smart terminal, cause the one or more computer processors to perform steps comprising:
receiving, from a browser, a browsing request to access a Uniform Resource Locator (URL) or an address for externally hosted content, wherein the smart terminal is prevented from directly accessing the URL or the address;
checking the URL or the address against an allowed list or a prohibited list;
directing the browser to the URL or the address in response to the URL or the address being on the allowed list, or the URL or the address not being on the prohibited list; and
providing a secure connection between the browser and the URL or the address.

16. The non-transitory computer readable storage medium of claim 15, wherein a security tool prevents the smart terminal from directly accessing the URL or the address.

17. The non-transitory computer readable storage medium of claim 15, wherein the allowed list or the prohibited list is based on a security policy.

18. The non-transitory computer readable storage medium of claim 15, wherein the allowed list or the prohibited list is provided by an application development service.

19. The non-transitory computer readable storage medium of claim 15, wherein traffic to and from the browser flows through the secure server.

20. The non-transitory computer readable storage medium of claim 19, further including instructions stored thereon, which when read and executed by the one or more computer processors on a smart terminal, cause the one or more computer processors to perform steps comprising: signing content communicated between the URL or the address and the browser.
